(19) United States
(12) Patent Application Publication
(10) Pub. No.: US 2014/0362616 A1
(43) Pub. Date: Dec. 11, 2014

(54) HIGH VOLTAGE SWITCHING POWER SUPPLY

(71) Applicants: POSTECH CO., LTD., Anyang-si (KR); CHEONGJU University Industry & Academy Cooperation Foundation, Cheongju-si (KR)

(72) Inventor: Tae-Young AN, Cheongju-si (KR)

(21) Appl. No.: 13/919,626

(22) Filed: Jun. 17, 2013

(30) Foreign Application Priority Data
Jun. 10, 2013 (KR) 10-2013-0065907

(51) Int. Cl. H02M 3/337

(52) U.S. Cl. CPC H02M 3/3376; H02M 3/337
USPC 363/25; 363/24

(57) ABSTRACT

A dual resonance circuit is formed of two transformers, two resonance inductors and two resonance capacitors for a resonance type switching power supply employing parallel connected transformers. The secondary winding of the transformer is configured in a center tap structure, and a top and bottom symmetrical voltage multiplying rectifier is connected to the secondary winding coupled with the parallel connected transformers, thereby obtaining the same effect as when one transformer is used. The present invention achieves a low loss in the typical resonance type half bridge power supply even though two transformers are employed, and the switching power supply with a lowered height and thinned structure can be provided with the aid of the optimized arrangements of the resonance devices. The internal power loss can be lowered by using two parallel connected transformers as compared to a resonance type switching power supply which employs one transformer.

### TECHNICAL FIELD

The present invention relates to a switching power supply, and in particular to a high voltage switching power supply which makes it possible to easily manufacture a compact-sized, thinner switching power supply in such a way to use two parallel connected transformers, which consequently divides the whole size of a transformer adapted to a switching power supply, the switching power supply comprising a top and bottom symmetrical voltage multiplying rectifier at a secondary winding coupled to each of parallel connected transformers.

### BACKGROUND ART

Some power loss is inevitable in a switching power supply because it is configured to constantly supply power and to convert lots of power. The power which loses inside is generally converted into heat, and the converted heat radiates to the outside, so a power conversion efficiency lowers in proportion to the converted heat. In worse case, the service life of product may be shortened accordingly. As for a large capacity power supply suitable for server class computers and medium and large size computers which are capable of performing a numerous data at a high speed, the electric power conversion efficiency and the size of the power supply are limited, so it is urgent to develop an improved design and manufacture method which can reduce a volume and a weight starting from the manufacture stage.

Power density means that electric power capacity is divided by the volume of power supply product. What the power density of a product is higher means that the product has more electric power capacity as compared to its outer size, which features may help manufacture a more compact-sized system. There are three ways that are known to increase electric power density.

First of all, when the switching frequency increases, the sizes of devices which are sensitive to frequencies change. When an electric power storage device like a transformer or a capacity has an increased frequency, the loads of energy storages decrease, so the size can be more reduced accordingly, which results in a compact-sized product.

Second of all, the electric power density can be increased by enhancing electric power conversion efficiency. When the electric power conversion efficiency is enhanced, the heating value decreases, and when the heating value decreases, the size of a heat sink or a conductor reduces, so a compact-sized power supply can be manufactured accordingly.

Lastly, the electric power density can be increased with the aid of an improved construction and an optimized arrangement of a product. The compactness and reliability of the product is directly related to how to optimize hundreds of devices which are used in a power supply. The optimized arrangements of the devices used in a magnetic core of a transformer and an inductor produce a good result.

In recent years, since a resonance type half-bridge converter employs a resonance type switching technology, a high efficiency electric power conversion can be advantageously obtained by reducing the loss in switching; however as output electric power increases, the magnetic core belonging to a transformer becomes bulky when using a transformer suitable for a large electric power, which retards the compactness of a power supply. In order to improve the above mentioned problems, a parallel connected transformer is widely used, which can increase the height of the transformer and the output electric power with the aid of two cores.

The above mentioned method is directed to a transformer construction simply employing a parallel structure which makes it hard to meet a resonance switching condition, and it is hard to obtain an optimized operation in a switching frequency range and to enhance the reliability of a switching power supply, a result of which the compactness of a system including a transformer is hard to achieve.

### DISCLOSURE OF THE INVENTION

Accordingly, it is an object of the present invention to provide a high voltage switching power supply which makes it possible to manufacture a switching power supply with a lowered height and a thinned structure by optimizing the arrangement of two transformers and resonance devices for the sake of use of a parallel connected transformer in a switching power supply.

It is another object of the present invention to provide a high voltage switching power supply which has features in that an electric power efficiency can be enhanced by reducing the loss of an internal electric power using two parallel connected transformers as compared to a switching power supply which uses only one transformer for thereby lowering the internal heat of a switching power supply and enhancing reliability of a product.

It is further another object of the present invention to provide a high voltage switching power supply in which to obtain a stable high voltage with the aid of a symmetrical current, which was not obtained in a typical symmetrical voltage multiplying rectifier, by providing a top and bottom symmetrical voltage multiplying rectifier at a secondary winding of each transformer.

To achieve the above objects, there is provided a high voltage switching power supply which provides a high efficiency by reducing the height and volume of a power supply in such a way to distribute electric power which is required for the outputs of a power supply with the aid of two transformers.

To achieve the above objects, there is provided a high voltage switching power supply which provided a high reliability and efficiency while lowering the internal heats of a switching power supply by dividing the paths of current flow with the aid of two parallel connected transformers as compared to a typical switching power supply which uses only one transformer, for thereby reducing the loss of the internal electric power and consequently improving the efficiency of electric power conversion.

To achieve the above objects, there is provided a high voltage switching power supply, comprising two switches Q₁ and Q₂ which are connected in series with an input electric power; two resonance inductors L_{R1} and L_{R2} which are parallel connected to the node between the two switches Q₁ and Q₂; two transformers T₁ and T₂ the primary windings of which are connected in series to the two resonance inductors L_{R1} and L_{R2}, and the secondary windings of which are connected to a center tap structure, the two transformers T₁ and T₂ being commonly connected to the ground; two resonance capacitors C_{R1} and C_{R2} which are connected in series between the primary windings of the two transformers T₁ and T₂ and the ground; and a 2-times voltage multiplying full-wave rectifier which is formed of one smoothing capacitor C₂ connected in series to the output of a center tap of the secondary winding and two diodes D₂ and D₈ parallel connected to the smoothing capacitor C₂.

In addition, the high voltage switching power supply further comprises a half-wave rectifier which is formed of two smoothing capacitors C₁ and C₇ which are connected in parallel to the secondary windings of the two transformers T₁ and T₂, and two diodes D₁ and D₇ which are connected in parallel to the output of a center tap of the secondary winding.

In addition, the high voltage switching power supply further comprises a control circuit which distributes an output voltage of the center tap and controls the same uniformly and compares with a reference voltage and generates a control voltage; a voltage-frequency conversion circuit which converts a control voltage of the control circuit into a frequency; and a switch driving circuit which controls the two switches to operate at a certain frequency.

The switching power supply using parallel connected transformers of the present invention provides a dual resonance circuit in which there are provided two resonance capacitors which are connected in series to two resonance inductors.

### ADVANTAGEOUS EFFECTS

The present invention has advantageous effects in that it is possible to manufacture a switching power supply with a lowered height and a thinned structure by providing the optimized arrangements of two transformers and resonance devices so that parallel connected transformers can be used in a switching power supply.

The present invention provides a reliable and high efficiency resonance type switching power supply which has a lowered internal heat by reducing the loss of internal electric power and improving electric power conversion efficiency in such a way to use two parallel connected transformers as compared to a typical resonance switching power supply which uses one transformer.

The present invention makes it possible to obtain a stable voltage that a user wants by providing a top and bottom symmetrical voltage multiplying rectifier at a secondary winding of each transformer.

### BRIEF DESCRIPTION OF THE DRAWINGS

The present invention will become better understood with reference to the accompanying drawings which are given only by way of illustration and thus are not limitative of the present invention, wherein;

FIG. 1 is a circuit diagram illustrating a high voltage switching power supply which employs a dual resonance circuit and a symmetrical 6-times voltage multiplying rectifier according to the present invention;

FIG. 2 is a circuit diagram illustrating a high voltage switching power supply which employs a dual resonance circuit and a symmetrical 2-times voltage multiplying rectifier according to the present invention;

FIG. 3 is an equivalent circuit diagram illustrating a high voltage switching power supply of FIG. 2; and

FIGS. 4A to 4C is views illustrating the waveforms of a high voltage switching power supply.

### MODES FOR CARRYING OUT THE INVENTION

The preferred embodiments of the present invention will be described with reference to the accompanying drawings. It is noted that the same elements are given the same reference numerals throughout the specification. The following detailed descriptions provide specific features of the present invention for the purpose of helping those who skilled in the art to fully understand. Throughout the descriptions, what are deemed to make unclear the features of the present invention will be omitted from the descriptions. The terms used throughout the descriptions are defined in consideration of the specific functions of the embodiments of the present invention, which are subject to changes depending on a user's or operator's intention, practice, etc. so the specific definitions of the terms should be made based on the contents disclosed throughout the specification.

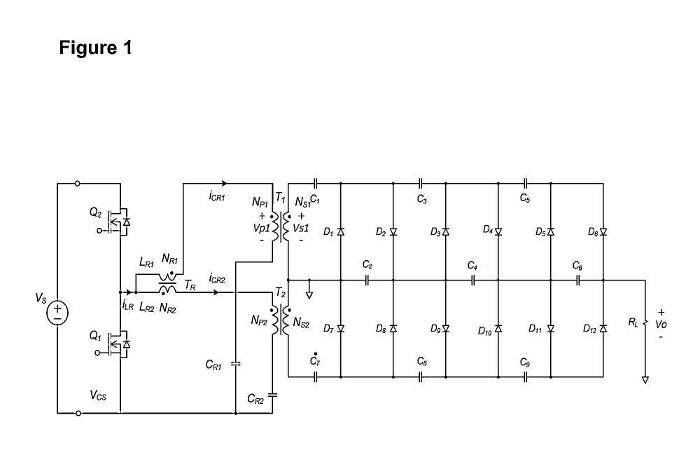

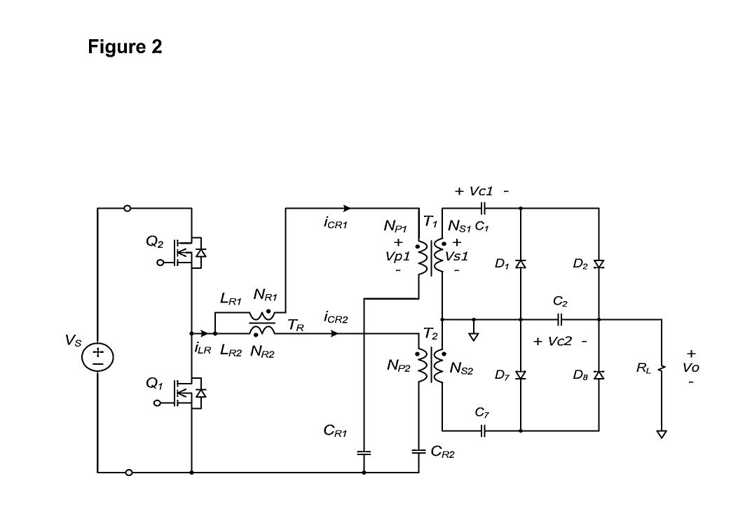

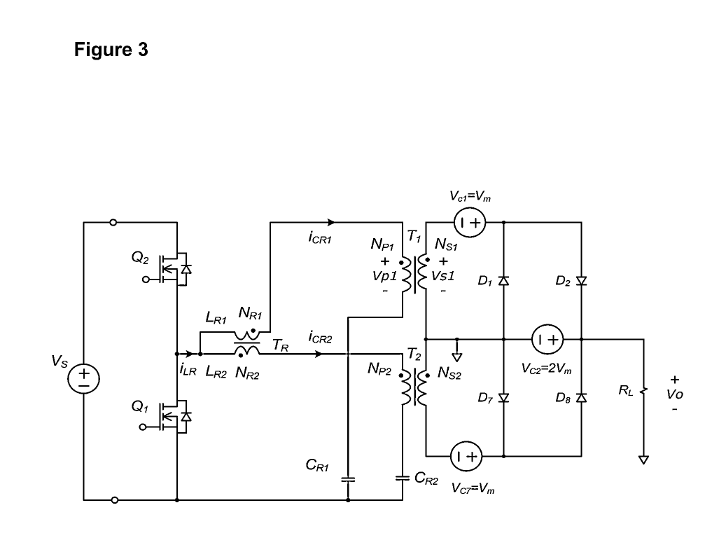

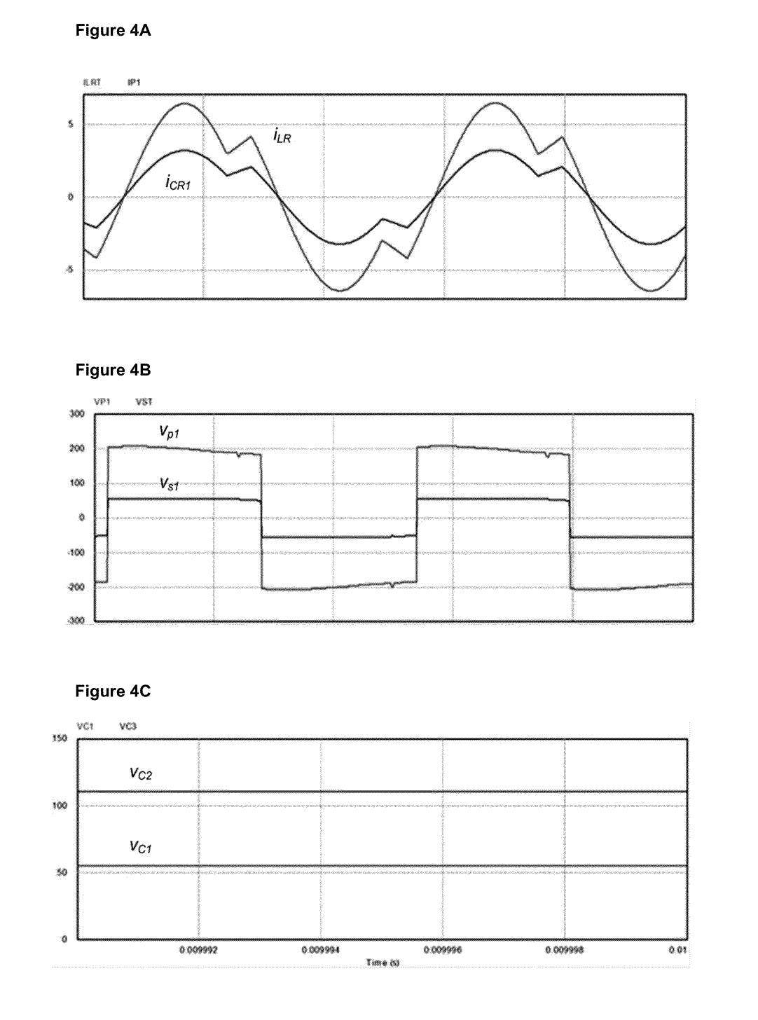

FIG. 1 is a circuit diagram illustrating a high voltage switching power supply which employs a dual resonance circuit and a symmetrical 6-times voltage multiplying rectifier according to the present invention, and FIG. 2 is a circuit diagram illustrating a high voltage switching power supply which employs a dual resonance circuit and a symmetrical 2-times voltage multiplying rectifier according to the present invention, and FIG. 3 is an equivalent circuit diagram illustrating a high voltage switching power supply of FIG. 2, and FIGS. 4A to 4C is views illustrating the waveforms of a high voltage switching power supply.

The constructions and operations of the high voltage switching power supply which employs a dual resonance circuit and a symmetrical voltage multiplying rectifier according to the present invention will be described with reference to FIGS. 1 to FIGS. 4C.

As shown in FIG. 2, the high voltage switching power supply according to the present invention comprises a dual resonance circuit formed of two resonance capacitors C_{R1} and C_{R2} and parallel connected transformers T₁ and T₂.

The high voltage switching power supply according to the present invention operates in such a way that when an input voltage Vs is supplied, the two switches Q₁ and Q₂ fast switch at a duty ratio of 50% in accordance with a control circuit, and as a result, a pulse voltage corresponding to the level of the input voltage V₅ is applied to the node of the intermediate portion between the two switches Q₁ and Q₂.

The pulse voltage applied to the node of the intermediate portion between the two switches Q₁ and Q₂ is converted into a sine wave signal as the current and the voltage resonate with the magnetizing inductances of the two resonance capacitors C_{R1} and C_{R2}, the two resonance inductors L_{R1} and L_{R2}, and the primary windings of the two transformers T₁ and T₂, respectively. At the secondary windings of the two transformers T₁ and T₂, the level of the resonance current varies based on the winding ratios (N_{P1}: N_{P2}:N_{S1}:N_{S2}) of the transformer.

The level-changed sine waves are half-wave rectified by a center tap winding structure of the secondary winding of the transformer, the two smoothing capacitors C₁ and C₇ and the diodes D₁ and D₇, and the half-wave rectified current wave signals are charged into the smoothing capacitors C₁ and C₇, and the two times higher voltage Vc2 as compared to the voltage Vc1 charged into the smoothing capacitors C₁ and C₇ is applied to the smoothing capacitor C₂ by the smoothing capacitor C₂ and the diodes D₂ and D₈.

The two times higher voltage Vc2 at the smoothing capacitor C₂ is a voltage which is supplied to the output terminal, and the smoothing capacitor C₂ operates as a switching power supply in such a way that it maintains a constant voltage V₀, and the voltage is converted into a constant direct current voltage, so electric power is supplied to a load resistor R_{L}, for thereby performing a direct current—direct current conversion.

For the above mentioned operations, the high voltage switching power supply according to the present invention might comprises a control circuit which distributes the output voltages of the output tap of the secondary winding of the transformer and constantly controls the same and compares the same with a reference voltage for thereby generating a proper control voltage. There might be further provided a switch driving circuit which controls a voltage-frequency conversion circuit converting a control voltage of a control circuit into a frequency and two switches Q₁ and Q₂ to operate at proper frequencies.

As shown in FIG. 1, the present invention might provide a much higher voltage power supply using a dual resonance circuit and a symmetrical 6-times voltage multiplying rectifier.

FIG. 3 is an equivalent circuit diagram illustrating a high voltage switching power supply of FIG. 2. The high voltage switching power supply according to the present invention will be described with reference to FIG. 3. The high voltage power supply formed of a dual resonance circuit and a symmetrical 2-times voltage multiplying rectifier according to the present invention operates in such a way that when an input voltage Vs is supplied, the two switches Q₁ and Q₂ fast switch by a control circuit at a duty ratio of 50%, so a pulse voltage corresponding to the level of an input voltage Vs can be applied to the node of the intermediate portion between the two switches Q₁ and Q₂.

The pulse voltage applied to the node of the intermediate portion between the two switches Q₁ and Q₂ comes to resonate with the current and voltage by the magnetizing inductances of the two resonance capacitors C_{R1} and C_{R2}, the two resonance inductors L_{R1} and L_{R2}, and the primary windings of the two transformers T₁ and T₂, so the pulse voltage is converted into a sine wave form, and the level of the resonance current varies at the secondary winding of the transformer based on the winding ratios N_{P1}:N_{P2}:N_{S1}:N_{S2} of the transformer.

The level-changed sine wave signal is half have rectified by a winding structure of a center tap of the secondary winding of the transformer, the two smoothing capacitors C₁ and C₇ and the diodes D₁ and D₇, and the half wave-rectified current wave voltage Vₘ is charged into the smoothing capacitors C₁ and C₇. At this time, the two times higher voltage 2Vₘ as compared to the voltage Vₘ charged into the smoothing capacitors C₁ and C₇ is applied to the smoothing capacitor C₂ by means of the smoothing capacitor C₂ and the diodes D₂ and D₈ and is outputted to the output terminal.

The smoothing capacitor C₂ operates as a switching power supply in such a way that it maintains a constant voltage V₀, and the voltage is converted into a constant direct current voltage, so electric power is supplied to a load resistor R_{L}, for thereby performing a direct current—direct current conversion.

FIGS. 4A to 4C are views illustrating major waveforms of a high voltage switching power supply of FIG. 2, which waveforms show ideal operation waveforms obtained from the circuit of FIG. 2.

Referring to FIGS. 1 to 3, the waveforms of FIGS. 4A to 4C will be described. The red line (ILRT) of FIG. 4A indicates the current i_{LR} flowing at the resonance inductor L_{R1}, and the blue line (IPI) indicates the current i_{CR1} flowing at the resonance capacitor C_{R1}. The red line of FIG. 4B indicates the primary winding voltage Vp1 of the transformer T₁, and the blue line (VST) indicates the secondary winding voltage Vs1 of the transformer T₁. The red line (VC1) of FIG. 4C indicates the voltage Vc1 of the smoothing capacitor C₁ of the secondary winding of the transformer T₁, and the blue line (V3C) indicates the voltage Vc2 of the smoothing capacitor C₂.

From the theoretical waveforms shown in FIGS. 4A to 4C and the constructions of FIGS. 1 to 3, it seems that the high voltage switching power supply using a dual resonance circuit and a symmetrical 2-times voltage multiplying rectifier according to the present invention operates normally.

As described above, the high voltage switching power supply according to the present invention provide the optimized arrangements of the two transformers and the resonance devices, which construction ensures parallel connected transformers in the switching power supply, for thereby achieving the lowered height and the thinned construction of the switching power supply.

The high voltage switching device according to the present invention employs two parallel connected transformers, which construction makes it possible to reduce the internal power loss as compared to the resonance type switching power supply which employs one transformer for thereby improving the power conversion efficiency along with the lowered internal heat of the switching power supply, so the resonance type switching power supply with high reliability and efficiency can be provided.

The high voltage switching device according to the present invention ensures a stable provision of a high voltage that a user wants by disposing top and bottom symmetrical multiple-times voltage multiplying rectifiers at the secondary windings of two transformers, which makes it possible to always obtain a high voltage that a user wants.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

What is claimed is:

1. A high voltage switching power supply, comprising:
two switches Q₁ and Q₂ which are connected in series with an input electric power;
two resonance inductors L_{R1} and L_{R2} which are parallel connected to the node between the two switches Q₁ and Q₂;
two transformers T₁ and T₂ the primary windings of which are connected in series to the two resonance inductors L_{R1} and L_{R2}, and the secondary windings of which are connected to a center tap structure, the two transformers T₁ and T₂ being commonly connected to the ground;
two resonance capacitors C_{R1} and C_{R2} which are connected in series between the primary windings of the two transformers T₁ and T₂ and the ground; and
a 2-times voltage multiplying full-wave rectifier which is formed of one smoothing capacitor C₂ connected in series to the output of a center tap of the secondary winding and two diodes D₂ and D₈ parallel connected to the smoothing capacitor C₂.

2. A high voltage switching power supply according to claim 1, further comprising a half-wave rectifier which is formed of:
two smoothing capacitors C₁ and C₇ which are connected in parallel to the secondary windings of the two transformers T₁ and T₂, and
two diodes D₁ and D₇ which are connected in parallel to the output of a center tap of the secondary winding.

3. A high voltage switching power supply according to claim 1, further comprising:
a control circuit which distributes an output voltage of the center tap and controls the same uniformly and compares with a reference voltage and generates a control voltage;
a voltage-frequency conversion circuit which converts a control voltage of the control circuit into a frequency; and
a switch driving circuit which controls the two switches to operate at a certain frequency.
